(19) United States
(12) Patent Application Publication
(10) Pub. No.: US 2026/0073270 A1
(43) Pub. Date: Mar. 12, 2026

(54) Generation and Compilation of Representations of Fault Tolerant Quantum Circuits

(71) Applicant: Google LLC, Mountain View, CA (US)

(72) Inventors: Bochen Tan, Los Angeles, CA (US); Yuezhen Niu, Los Angeles, CA (US); Craig Gidney, Goleta, CA (US)

(21) Appl. No.: 18/799,760

(22) Filed: Aug. 9, 2024

Related U.S. Application Data
(60) Provisional application No. 63/518,693, filed on Aug. 10, 2023.

(51) Int. Cl. G06N 10/70; G06N 10/80

(52) U.S. Cl. CPC G06N 10/70; G06N 10/80

(57) ABSTRACT

One example aspect of the present disclosure is directed to a method for implementing fault-tolerant quantum computing. The method includes receiving a set of inputs for a fault-tolerant quantum-computation circuit (QCC). The set of inputs includes an indication of a set of logical qubits and an indication of a set of quantum-logic stabilizers that the QCC is configured to perform on the set of logical qubits. A satisfiability modulo theory (SMT) model for the QCC is generated based on the set of inputs. The SMT model includes a set of constraints. A set of values to populate a data structure. The set of values satisfies the set of constraints of the SMT model. The data structure populated by the set of values encodes an intermediate representation (IR) of a time evolution of the QCC performing the set of quantum-logic stabilizers on the set of logical qubits.

### PRIORITY CLAIM

This application claims priority to U.S. Provisional App. No. 63/518,693 (Attorney Docket No. GGLQ-165-P) having a filing date of Aug. 10, 2023, and entitled “GENERATION AND COMPILATION OF REPRESENTATIONS OF FAULT TOLERANT QUANTUM CIRCUITS,” the contents of which are herein incorporated in their entirety.

### FIELD

The present disclosure relates generally to quantum computing and information processing systems, and more particularly to generating and compiling representations of fault-tolerant quantum circuits.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0>+b|1> The “0” and “1” states of a digital computer are analogous to the |0> and |1> basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for implementing fault-tolerant quantum computing. The method includes receiving a set of inputs for a fault-tolerant quantum-computation circuit (QCC). The set of inputs includes an indication of a set of logical qubits and an indication of a set of quantum-logic stabilizers that the QCC is configured to perform on the set of logical qubits. A satisfiability modulo theory (SMT) model for the QCC is generated based on the set of inputs. The SMT model includes a set of constraints. A set of values to populate a data structure. The set of values satisfies the set of constraints of the SMT model. The data structure populated by the set of values encodes an intermediate representation (IR) of a time evolution of the QCC performing the set of quantum-logic stabilizers on the set of logical qubits.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure;

FIG. 2A illustrates “compact” pipe diagrams that show a CNOT operation on two logical qubits, according to various embodiments;

FIG. 2B illustrates “elongated” pipe diagrams that show the CNOT operation of FIG. 2A, according to various embodiments;

FIG. 3 shows a lattice surgery operation, according to various embodiments;

FIG. 4 shows a ZX diagram and a corresponding pipe diagram, according to various embodiments;

FIG. 5A shows various pipe diagrams displaying visual manifestations of various structural variables, according to various embodiments;

FIG. 5B shows various pipe diagrams displaying visual manifestations of various correlational surface variables, according to various embodiments;

FIG. 6A shows various pipe diagrams displaying visual manifestations of various structural internal constraints, according to various embodiments;

FIG. 6B shows various pipe diagrams displaying visual manifestations of various stabilizer boundary constraints, according to various embodiments;

FIG. 7 shows a software structure 700 for a lattice surgery compiler, according to various embodiments; and

FIG. 8 depicts a flow chart diagram of an example method 800 for implementing fault-tolerant quantum computing, according to various embodiments.

### DETAILED DESCRIPTION

Example aspects of the present disclosure are directed to methods, architectures, and hardware configurations that enable generating and compiling representations of fault-tolerant quantum circuits for quantum computing systems. The embodiments include automating the generation of lattice surgery intermediate representations (LaSIR) that can store “pipe diagrams” representing fault-tolerant quantum circuits. The embodiments also include automating the checking of validity and functionality constraints of the LaSIRs and/or pipe diagrams. The embodiments furthermore automatically manipulate and verify instances of the LaSIR. The embodiments provide visualization tools for the LaSIRs and/or pipe diagrams. A LaSIR may be simply referred to as an intermediate representation (IR) throughout.

The pipe diagrams of the embodiments may encode lattice surgery operations for fault tolerant quantum computation employing a (2D) lattice of physical qubits. The lattice may be used to implement quantum error correction (QEC) codes. Such QEC codes include, but are not limited to, topological surface codes. In various QEC codes, including surface codes, a “patch” of physical qubits from the lattice implements an error-tolerant logical qubit. Because logical qubits are implemented via a 2D patch of physical qubits, the terms logical qubit and patch may be used interchangeably throughout. The logical qubits may be comprised of a set of data (physical) qubits and a set of syndrome (physical) qubits. Syndrome qubits may be referred to as measurement qubits. The data for a logical qubit may be redundantly stored in the quantum states of the data qubits. The syndrome qubits provide ancilla qubits for projective measurements of the parity (both X and Z parity) of pairs of the data qubits. Via the syndrome qubits, the parity of pairs of data qubits may be determined via cycles of (non-destructive) syndrome measurements. When an odd-parity measurement occurs in one or more syndrome qubits, it can be inferred that an error (e.g., an X-error, a Y-error, or a Z-error) has occurred in one or more of the data qubits corresponding to the one or more syndrome qubits. Because all operations on qubits are reversible, an operation reversing the error may be performed on the affected qubit. The process of monitoring and manipulating (e.g., performing operations on) the logical qubits for fault-tolerant quantum computing may be referred to as lattice surgery.

The basic idea of lattice surgery involves the manipulation of logical qubits using local operations on a physical qubit lattice. By performing these local operations on selected qubits, logical qubits can become entangled and disentangled (e.g., merged and separated) to effectively execute transversal quantum gates and computations. The surgery refers to the process of reconfiguring the lattice of physical qubits to implement logical gates. The pipe diagrams and LaSIRs of the embodiments encode and provide visualizations of lattice surgery operations.

Traditionally, people manually construct graphical representations of fault-tolerant quantum computations but this approach is not viable when the size of computations gets large. Moreover, there is no known tool to efficiently optimize the physical implementation of fault-tolerant circuits. This poses a significant obstacle towards realizing scalable quantum computation where sub-optimality of fault-tolerant circuit compilation can incur enormous amounts of overhead that prevent us from realizing the computation in laboratory computers. The embodiments below overcome these challenges by providing tools for the generation and compilation of pipe diagrams.

One example aspect of the present disclosure is directed to a method for implementing fault-tolerant quantum computing. The method includes receiving a set of inputs for a fault-tolerant quantum-computation circuit (QCC). The set of inputs includes an indication of a set of logical qubits and an indication of a set of quantum-logic stabilizers that the QCC is configured to perform on the set of logical qubits. A satisfiability modulo theory (SMT) model for the QCC is generated based on the set of inputs. The SMT model includes a set of constraints and a set of values to populate a data structure. The set of values satisfies the set of constraints of the SMT model. The data structure populated by the set of values encodes an intermediate representation (IR) of a time evolution of the QCC performing the set of quantum-logic stabilizers on the set of logical qubits.

Aspects of the present disclosure provide a number of technical effects and benefits. For instance, the tools enable fault tolerant computing via the automation of the generation and compilation of lattice surgery operations, including the automatic generation of pipe diagrams, according to various constraints of lattice surgery techniques. Currently, researchers have been constructing the pipe diagrams manually with 3D modeling software. Although the GUIs of 3D modeling software provide some ways to construct, manipulate, and inspect the diagrams, many challenges arise with this manual approach, which are specified below. Therefore, the automated tools are necessary to implement fault-tolerant quantum computation that is scalable for large numbers of logical qubits. When the diagrams get large, it is hard to visually check all the color matching constraints because a view is blocked by components on the outside. For a diagram with n ports, there are at most n correlation surfaces to check. The file formats of 3D modeling software are difficult to decode. Some of these formats are also proprietary. Thus, it is challenging to perform formal verification of the validity and functionality of the diagrams and compile to lower-level instructions. Manually constructed diagrams are usually intuitive to humans in some way. Without an automated tool, the solution space for the generation of pipe diagrams is not fully explorable without tools that automate the generation and compilation of pipe diagrams. The embodiments overcome these challenges by defining an intermediate representation (IR) (e.g., a LaSIR) that can store the diagrams in numbers via a data structure. Validity and functionality constraints are generated based on terms of the IR. The embodiments include tools that automatically manipulate and verify instances of the IR. The embodiments additionally include a visualization tool for the IR.

As used herein, the use of the term “about” in conjunction with a numerical value refers to within 10% of the stated amount

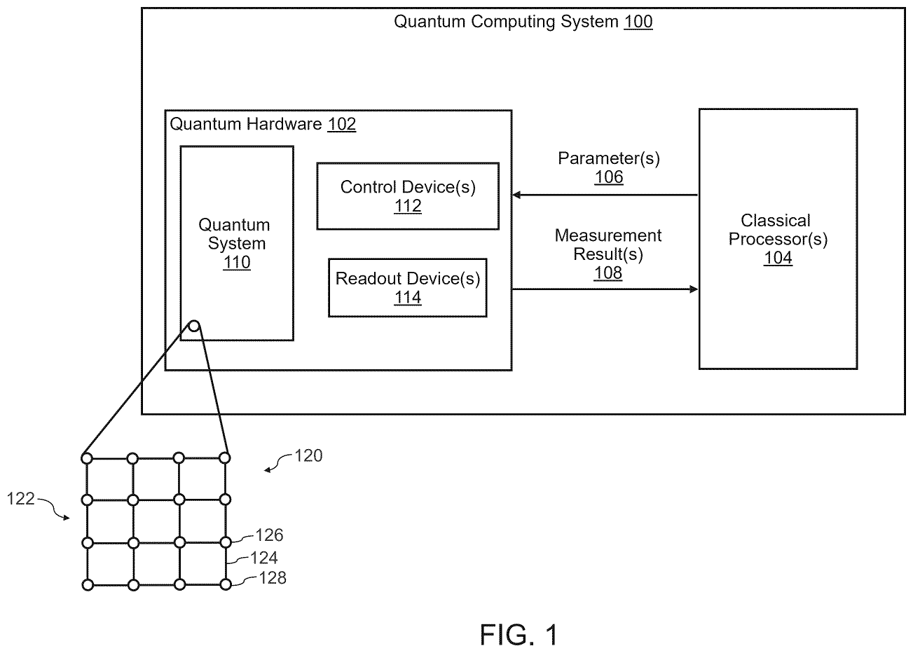

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots, or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit, and the control device(s) 112 and readout devices(s) 114 may implement one or more quantum logic gates that operate on the quantum hardware 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameters 106 from the classical processors 104. The quantum hardware 102 may use the received physical control qubit parameters 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0> and |1> states of an element of the quantum system 110, such as a qubit, to measure the state of the element (e.g., the qubit). For example, the resonance frequency of a readout resonator can take on different values when a qubit is in the state |0> or the state |1>, due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the quantum system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

### Pipe Diagrams for Lattice Surgery

The embodiments are directed to systems, methods, architectures, and hardware configurations for fault-tolerant quantum computation schemes. In such schemes, logical qubits are encoded in patches of surface code memory (e.g., 2D arrays of qubits). Because of the correspondence between logical qubits and patches, the terms may be used interchangeably. Logical operations may be performed by lattice surgery, i.e., choosing whether to turn on or off the syndrome measurements between patches and choosing the basis of these measurements. More particularly, in one non-limiting example, lattice surgery may be employed when implementing transversal quantum gates across two or more logical qubits. Such multi-qubit transversal gates may be entangling gates (e.g., a CNOT operation between a first qubit (e.g., the control qubit) and a second qubit (e.g., the target qubit)). Lattice surgery may be employed such that qubit interactions are “local” (e.g., keeping physical qubit interactions local (e.g., interactions only between nearest neighboring qubits within a 2D qubit array)).

Lattice surgery may involve “merging” (or sewing) the two logical qubits at a boundary of each of the two logical qubits. Once merged, transversal operations may be applied to the physical qubits forming the merged logical qubits, conserving locality. Once transversally operated on, the merged logical qubits may be separated again to re-form two separate logical qubits. When merging and separating two logical qubits, it may be required that the two boundaries of the two logical qubits have a common measurement basis (e.g., the stabilizers on the boundary must be of a common type). By rotating the measurement basis, gates that provide π/2 rotations (e.g., a Hadamard gate) may be employed to match-up the boundary conditions on the two logical qubits. Once severed, separated, or split, another Hadamard operation may rotate the basis at the boundaries to transform the boundaries back to their prior basis. One way to visualize lattice surgery is “pipe diagrams.”

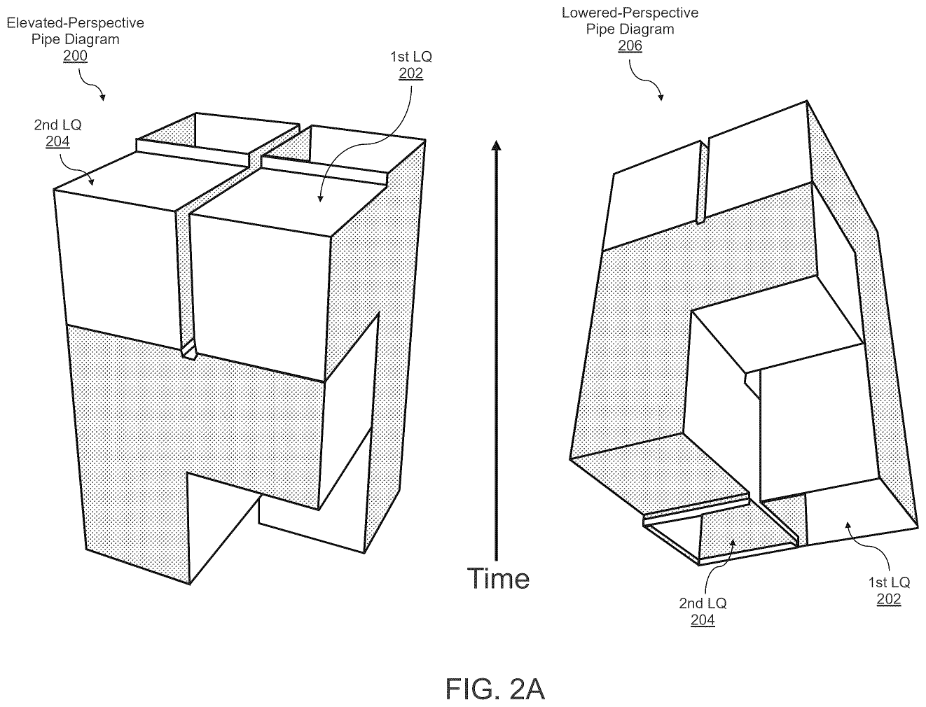

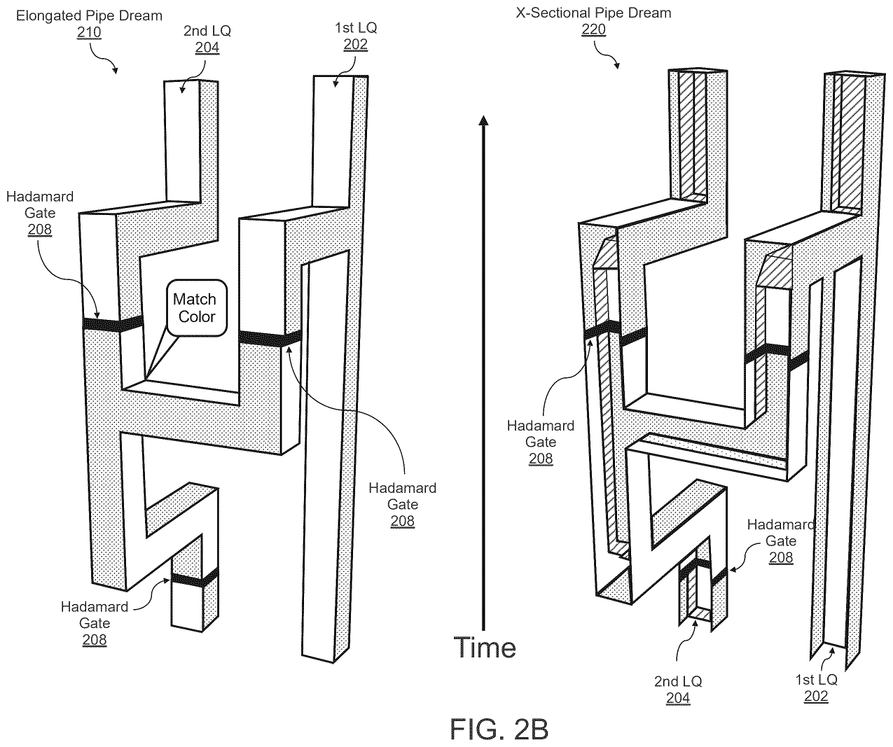

FIG. 2A illustrates “compact” pipe diagrams that show a CNOT operation on two logical qubits, according to various embodiments. More particularly, FIG. 2A illustrates an elevated-perspective pipe diagram 200 and a lowered-perspective pipe diagram 206. Both of these pipe diagrams show the merging and separating of a first logical qubit (LQ) 202 and a second LQ 204 in order to perform a CNOT operation of the two LQs via lattice surgery. In these pipe diagrams (as well as the pipe diagrams shown in the remaining figures), the vertical direction represents a temporal axis, while logical qubit patches are represented by horizontal planes. As time flows upwards, a patch evolves into a “cube.” Note that, as used herein, a cube need not have symmetric dimensions horizontally (spatially) or vertically (temporally). The color of cubes, tubes, and edges in a pipe diagram is a critical concept. Given the limitations of the colorless figures included herein, the “color” of pipe diagrams are discussed in terms of shaded, non-shaded (e.g., white or unshaded), and black throughout.

In the pipe diagrams throughout, a shaded surface shows a Z-basis boundary of the LQ and a non-shaded surface shows a X-basis boundary for the LQ, where the basis refers to the measurement basis of the stabilizers on the boundary. In some embodiments that are configured to generate pipe diagrams with a greater diversity of colors, shaded surfaces (corresponding to Z-basis edges/boundaries/stabilizers) may be blue. In such embodiments, non-shaded surfaces (corresponding to X-basis edges/boundaries/stabilizers) may be red. As discussed below, Hadamard operations (which rotate basis between Z-types and Z-types) may be color coded as black in the figures. In some embodiments, the Hadaramard operates may be color coded as yellow. Thus, throughout, edges/boundaries/stabilizers that are Z-type may be referred to as shaded or blue. Edges/boundaries/stabilizers that are X-type may be referred to as non-shaded (or unshaded or white) or red. Hadamard operations/gates may be referred to as black or yellow.

Each patch in each surface code cycle is represented by a cube, corresponding to d*d physical qubits going through d rounds of syndrome extractions, where d is the code distance. To visualize the topological properties clearly, the space between these cubes may be elongated to form tubes connected via edges as shown in FIG. 2B

FIG. 2B illustrates “elongated” pipe diagrams that show the CNOT operation of FIG. 2A, according to various embodiments. More particularly, FIG. 2B shows an elongated pipe diagram 210 that corresponds to the elevated-perspective pipe diagram 200 of FIG. 2A. FIG. 2B also shows a cross-sectional pipe diagram 220 that corresponds to the elongated pipe diagram 210. In these elongated pipe diagrams, the Hadamard gates 208 are also shown.

The pipe diagrams of FIGS. 2A-2B show a performance of a CNOT gate. By the rules of lattice surgery, color matching constraints are required: when two edges touch one another, the surfaces that are touching must have the same color. (See “Match Color” annotation of elongated pipe diagram 210 of FIG. 2B). That is, colors of the surfaces/tubes should match when two tubes touch. A special case exists with a Hadamard gate (e.g., a black ring) which switches the coloring of vertical edges because the Hadamard gates 208 switch the measurement basis for the boundaries.

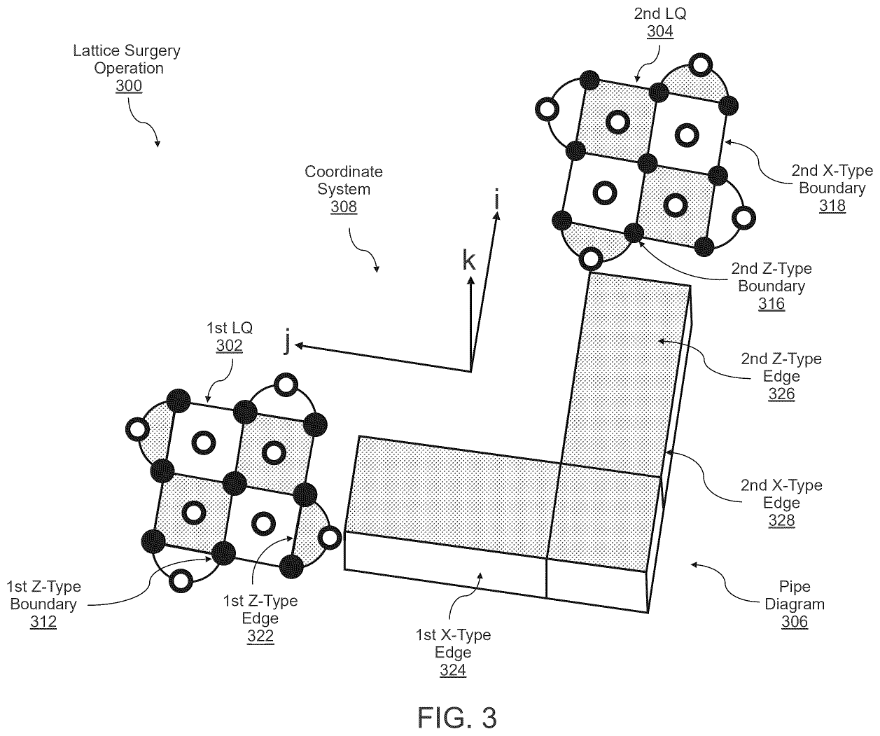

FIG. 3 shows a lattice surgery operation 300, according to various embodiments. The lattice surgery operation 300 connects (or merges) a first LQ 302 and a second LQ 304. As indicated by the “checkerboard” patterns on the first LQ 302 and the second LQ 304, a “rotated” ZX-basis surface code is employed to encode the logical qubits. The patches and checkerboard pattern indicate that the surface code is implemented on a 2D qubit array with local-qubit interactions. The pipe diagram 306 shows the merging of the two LQs, under the lattice surgery operations 300. Also, the coordinate system 308 is used to define surfaces, edges, and boundaries of the patches, as well as planes for the tubes of the pipe diagram 306. More specifically, the coordinate surface defines three-orthogonal planes: the IJ plane, the JK plane, and the KI plane. Furthermore, I-edges, J-edges, and K-edges of the pipe diagram 306, as well as corresponding boundaries of the patches may be defined via the coordinate system 308.

In the logical qubits/patches, the boundaries with the shaded semicircles are Z-boundaries, and the boundaries with the non-shaded semicircles signify X-boundaries. By the rules of lattice surgery, logical qubits/patches can only be merged on the same boundary type. Recall that the edges of the tubes of the pipe diagram 306 correspond to boundaries of the logical qubits/patches. The edges of the tubes are elongated to see them more clearly.

More particularly, the first LQ 302 has a first Z-type boundary 212 and a first X-type boundary 314. Similarly, the second LQ 204 has a second Z-type boundary 316 and a second X-type boundary 318. The pipe diagram 306 has a first Z-type edge 322 that corresponds to the first Z-type boundary 312 of the first LQ 302. Due to its correspondence with the first Z-type boundary 312 of the first LQ 302, the first Z-type edge 322 is shaded and lies in the IJ plane. The pipe diagram 306 has a first X-type edge 324 that corresponds to the first X-type boundary 314 of the first LQ 302. Due to its correspondence with the first X-type boundary 314 of the first LQ 302, the first X-type edge 324 is unshaded and lies in the JK plane. The pipe diagram 306 has a second Z-type edge 326 that corresponds to the second Z-type boundary 316 of the second LQ 304. Due to its correspondence with the second Z-type boundary 316 of the second LQ 304, the second Z-type edge 326 is shaded and lies in the IJ plane. The pipe diagram 306 has a second X-type edge 328 that corresponds to the second X-type boundary 318 of the second LQ 304. Due to its correspondence with the second X-type boundary 318 of the second LQ 304, the second X-type edge 328 is non-shaded and lies in the IK plane.

To merge the first LQ 302 and the second LQ 304, the pipe diagram 306 is generated. To generate the pipe diagram 306, the first Z-type boundary 312 of the first LQ 302 is elongated along the J-axis to form the first Z-type edge 322 of the pipe diagram 306. The first X-type boundary 314 of the first LQ 302 is elongated in the J-axis to form the first X-type edge 324 of the pipe diagram 306. The second Z-type boundary 316 of the second LQ 304 is elongated along the I-axis to form the second Z-type edge 326 of the pipe diagram 306. The second X-type boundary 318 of the second LQ 304 is elongated in the I-axis to form the second X-type edge 328 of the pipe diagram 306. Note that all the matching edges of the pipe diagram 306 match in shading/unshading to correspond with matching measurement basis constraints when merging the first LQ 302 with the second LQ 304.

Returning to the CNOT operation of FIGS. 2A-2B, and to ensure the lattice surgery functionally implements a CNOT, there are further constraints that check “correlation surfaces” from the inputs to the outputs. For example, a CNOT operation transforms IZ at inputs to ZZ at outputs. Thus, the corresponding correlation surface that connects the two shaded sides of the second LQ 204 of the cross-sectional pipe diagram 220 of FIG. 2B is not present in the first LQ qubit 302. By following the propagation of this surface, at the outputs, this surface touches two shaded sides of both the first LQ 302 and the second LQ 304. Note that the distinction between input and output ports is artificial. All ports may be treated as outputs, then the Pauli transforms become stabilizers. In this example, instead of IZ→ZZ, one can also say there is a stabilizer IZZZ at the four ports.

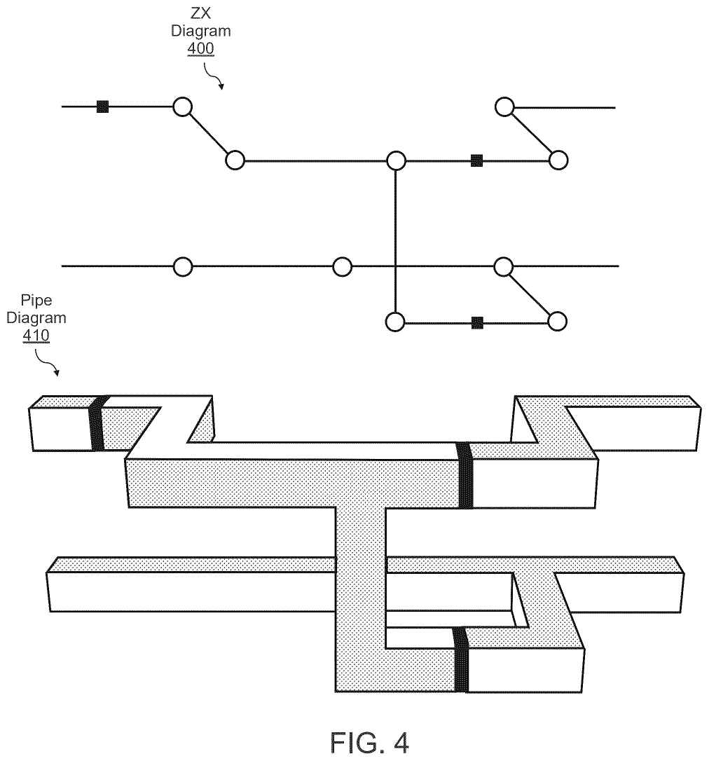

Combined with other special components (initializing and measuring logical qubits in Y basis, and T injection), pipe diagrams may be used to express any quantum computation. Pipe diagrams may be represented with ZX diagrams of the ZX calculus: each cube is a spider, if the color that does not fold is shaded, then the cube is a Z-spider without phase; if that color is non-shaded, then the cube is an X-spider without phase. FIG. 4 shows a ZX diagram 400 and a corresponding pipe diagram 410, according to various embodiments.

### Automating the Generation of Pipe Diagrams

Currently, researchers have been constructing the pipe diagrams manually with 3D modeling software packages. Although the GUIs of these software packages provide some ways to construct, manipulate, and inspect the diagrams, many challenges arise with this manual approach, which we specify below. Therefore, an automated tool is necessary. For instance, when the pipe diagrams get large, it is hard to visually check all the color matching constraints because our view is blocked by components on the outside. For a diagram with n ports, there are at most n correlation surfaces to check. Additionally, the file formats of 3D modeling software packages are difficult to decode. Some of these formats are also proprietary. Thus, it is challenging to perform formal verification of the validity and functionality of the diagrams and compile to lower-level instructions. Furthermore, manually constructed diagrams are usually intuitive to humans in some way. There may exist better diagrams (lower spacetime volume) that are not intuitive. Without an automated tool, one cannot fully explore the solution space.

The embodiments address the need for automating the generation of pipe diagrams by defining an intermediate representation (IR) that can store the pipe diagrams in numbers. That is, the embodiments include a data structure that encodes an IR of pipe diagrams. The embodiments are also configured to formulate validity and functionality constraints in terms of the IR. The embodiments include tools that automatically manipulate and verify instances of the IR. Various embodiments also include a visualization tool for the IR.

### Lattice Surgery Intermediate Representation (LaSIR)

The architecture of a LaSIR data structure (or simply an IR) will now be discussed. An IR consists of 1) ports, 2) structural variables, and 3) correlation surface variables data objects. There are five bounds: (nᵢ, nⱼ, nₖ) are the bounds on three spatial directions I, J, and K of the pipe diagram, nₚ=n is the number of ports, nₛ is the number of stabilizers, and. In the following example discussed throughout: nᵢ=2, nⱼ=3, nₖ=4, nₚ=n=4, nₛ=4.

Ports are edges with no cube on one end. Each port is specified by six numbers (i, j, k, d, c, e).
(i, j, k) is the spatial index of the starting cube of the edge.
d is the direction of the edge, can be I, J, or K. An I-edge goes from (i, j, k) to (i+1, j, k).
c is the color orientation of the edge, following the convention specified in the next subsubsection.
e is which end of the edge is empty, can be + or −. If e=−, the input/output will go in/out from the cube at (i, j, k); (i+1,j,k) will connect to other parts of the pipe diagram. If e=+, and d=I, it is the other way around, similar for d=J or K.

In the below example, there are 4 ports, all in K-edges with color orientation 0, two are + ends and two are − ends: (0,0,0,K,0,−), (1,0,0,K,0,−), (0,0,3,K,0,+), (1,0,3,K,0,+).

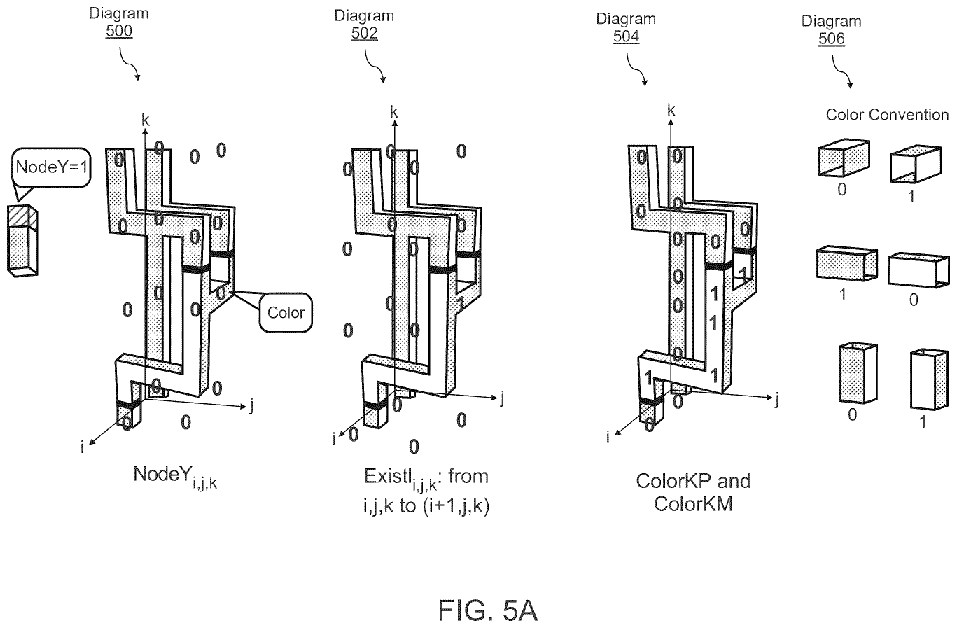

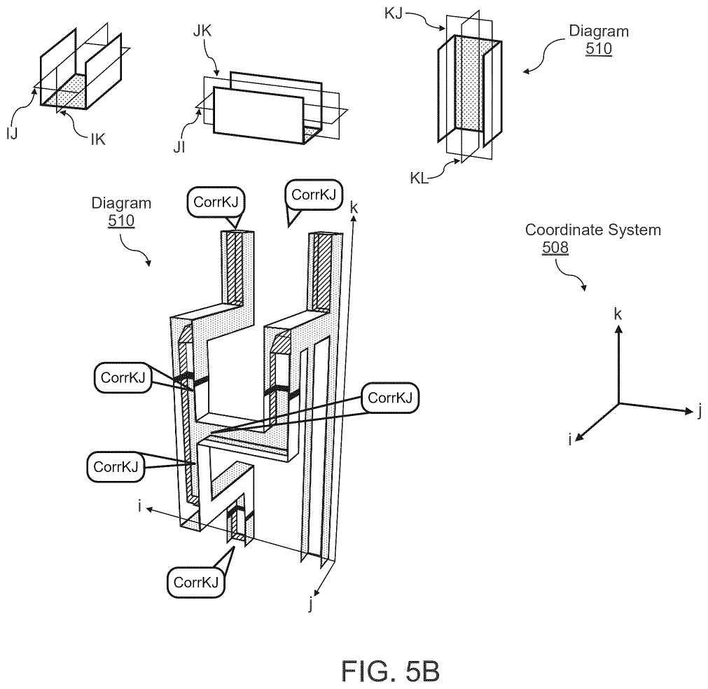

Structural variables of a IR data structure will now be discussed. Such structural variables include several 3D arrays of bits. Each array is of the same dimensions (nᵢ, nⱼ, nₖ). Each array element is indexed by a triplet (i,j,k) where 0≤i<nᵢ, 0=j<nⱼ, 0≤k<nₖ. FIG. 5A shows various pipe diagrams displaying visual manifestations of various structural variables, according to various embodiments. More particularly, FIG. 5A shows various diagrams that are informative of some of these bit arrays. Such bit array includes node bit array, exist bit arrays, and color bit arrays. Diagram 500 is instructive for interpreting node bit arrays as follows.
NodeY_{i,j,k}: if the cube at (i,j,k) is measuring or initializing logical qubits in Y basis. Such operations are denoted as green cubes. Since there is no Y cube in our example, all the values are 0 in the ‘NodeY’ subfigure.
ExistI_{i,j,k}: if there is an edge from cube (i,j,k) to cube (i+1,j,k). There is only one edge in the I direction, from (0,1,1) to (1,1,1). So, ExistI0,1,1=1 and all other values are 0 in the ‘ExistI’ subfigure. See diagram 502 of FIG. 5A.
ExistJ_{i,j,k}: if there is an edge from cube (i,j,k) to cube (i,j+1,k).
ExistK_{i,j,k}: if there is an edge from cube (i,j,k) to cube (i,j,k+1).
ColorI_{i,j,k}: the color orientation of the edge from cube (i,j,k) to cube (i+1,j,k). This value only makes sense if the corresponding ExistI_{i,j,k}=1. If ExistI_{i,j,k}=0, this value is ignored. See diagram 504 of FIG. 5A.
ColorJ_{i,j,k}: the color orientation of the edge from cube (i,j,k) to cube (i,j+1,k).
ColorK↑_{i,j,k}: the color orientation at the upper end of the edge from cube (i,j,k) to cube (i,j,k+1).
ColorK ↓_{i,j,k}: the color orientation at the lower end of the edge from cube (i,j,k) to cube (i,j,k+1). The ‘ColorK’ diagram shows both ColorKT and ColorKJ values. When these two form the same edge, a Hadamard gate (yellow ring in the middle of a K-edge) is added to make the resulting pipe diagram valid. Diagram 506 shows bit values for color conventions.

Correlational surface variables will now be discussed. FIG. 5B shows various pipe diagrams displaying visual manifestations of various correlational surface variables, according to various embodiments. Coordinate system 508 applies to both diagram 510 and diagram 512. Diagram 510 shows various planes labeled via coordinate system 508. Diagram 512 is used to interpret correlational surfaces defined by the planes of diagram 510. The structural variables specify the structure of a pipe diagram. The functionality of a diagram is given by stabilizers. There are some additional variables in LaSIR to verify the functionality of the constructed diagram. These are 4D arrays of bits. Compared to structural variables, they are additionally indexed by stabilizer s, 0≤s<ns≤n where n is the number of ports. See diagram 512 for the following discussion.
CorrIJ_{s,i,j,k}: for stabilizer s, in I-edge (i,j,k)→(i+1,j,k), is the correlation surface in the I-J plane present.
CorrIK_{s,i,j,k}: for stabilizer s, in I-edge (i,j,k)→(i+1,j,k), is the correlation surface in the K-I plane present.
CorrJK_{s,i,j,k}: for stabilizer s, in J-edge (i,j,k)→(i,j+1,k), is the correlation surface in the J-K plane present.
CorrJI_{s,i,j,k}: for stabilizer s, in J-edge (i,j,k)→(i,j+1,k), is the correlation surface in the I-J plane present.
CorrKI_{s,i,j,k}: for stabilizer s, in K-edge (i,j,k)→(i,j,k+1), is the correlation surface in the K-I plane present.
CorrKJ_{s,i,j,k}: for stabilizer s, in K-edge (i,j,k)→(i,j,k+1), is the correlation surface in the J-K plane present.

In this example, there are four ports and four stabilizers given: IZZZ, ZIZI, IXIX, XIXX. Diagram 512 shows IZZZ. The index of this stabilizer is 0. The color orientation is given as part of the input. In this case, all the ports are K-edges with color 1. Then, at inputs, IZ corresponds to CorrKI_{0,0,0,0}=0, CorrKJ_{0,0,0,0}=0, CorrKI_{0,1,0,0}=1, and CorrKJ_{0,1,0,0}=0. In other words, no correlation surface, neither in the KI or KJ plane, is present at port (0,0,0); however, at (1,0,0), correlation surface in the KI plane is present while KJ is not. Similarly, ZZ at the output corresponds to CorrKI_{0,0,0,3}=1, CorrKJ_{0,0,0,3}=0, CorrKI_{0,1,0,3}=1, and CorrKJ_{0,1,0,3}=0. A few Corr* variables that evaluate to 1 are marked out in diagram 512. The correlation surface does not interact with the color assignments, so for K-edges, there is only one bit for the KI plane and one bit for the KJ plane, and one does not need to specify which endpoint as in the Color* variables.

### Verification of LaSIR Through Constraints

There are two aspects that may be verified: whether the diagram is valid, and whether it implements the functionality. The constraints that correspond to these two verifications may be referred to, respectively, as ‘structure’ and ‘stabilizer’ constraints. For each aspect, boundary constraints and internal constraints may exist. The former is about the ports whereas the latter is about the internal connectivity

Structural boundary constraints will now be discussed. Structural boundary constraints may guarantee the consistency of Exist* variables with the ports. Below, if the subscripts are out of bounds, just ignore that term. Underline means negation of bits. We provide the cases for I direction ports. J and K direction ports are similar.

$$\cdot ∀ Port = ( i , j , k , I , c , - ) {ExistI}_{i , j , k} ∧ {ExistI}_{i - 1 , j , k} ∧ {ExistJ}_{i , j , k} ∧ {ExistJ}_{i , j - 1 , k} ∧ {ExistK}_{i , j , k} ∧ {ExistK}_{i , j , k - 1}$$

$$∀ Port = ( i , j , k , I , c , + ) {ExistI}_{i j , k} ∧ {ExistI}_{i + 1 , j , k} ∧ {ExistJ}_{i + 1 , j , k} ∧ {ExistJ}_{i + 1 , j - 1 , k} ∧ {ExistK}_{i + 1 , j , k} ∧ {ExistK}_{i + 1 , j , k - 1}$$

There may be edges that can cross spatial bounds (nᵢ, nⱼ, nₖ). Only ports are allowed to do so. We give an example to forbid non-port cross-bound I-edges. The constraints for J- and K-edges are similar. Let PI be the set of (j, k) such that there is a port on edge (n_{i-1,j,k}) to (n_{i,j,k}).
∀(j,k)∈PI ExistIn_{i-1,j,k}

### Structural Internal Constraints

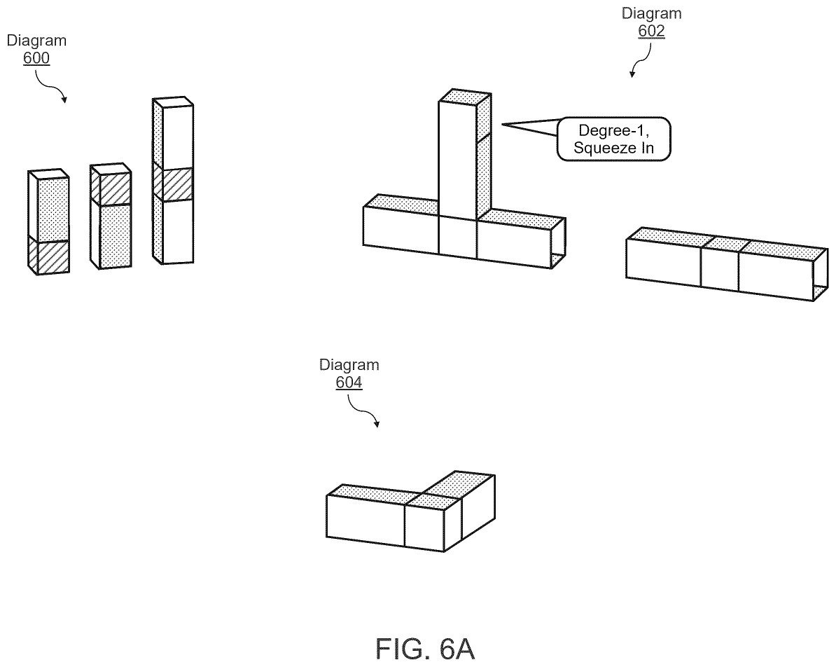

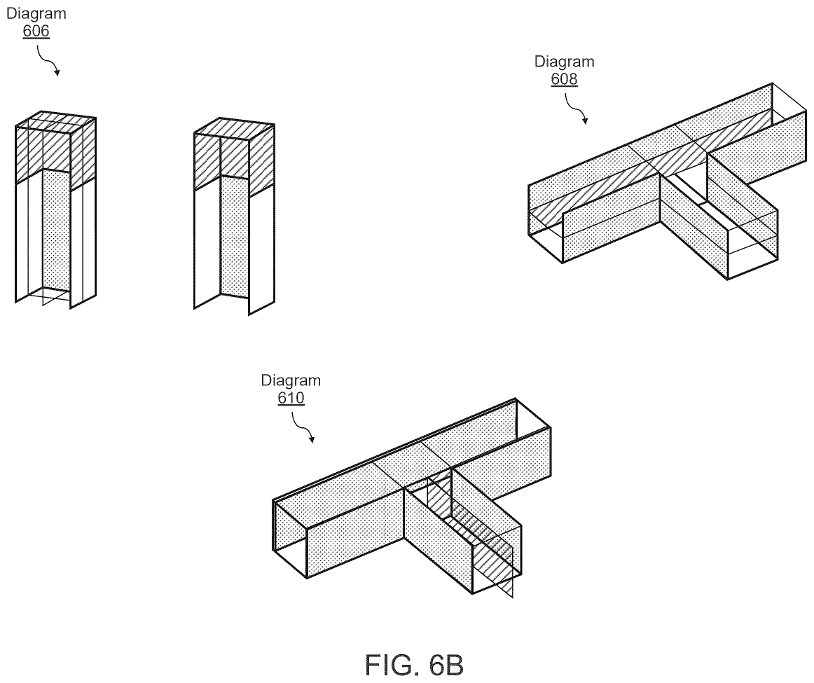

FIG. 6A shows various pipe diagrams displaying visual manifestations of various structural internal constraints, according to various embodiments. Structural internal constraints for Y cubes will now be discussed. See diagram 600 of FIG. 6A. Due to the protocol implementing Y cubes, the edges connecting to them may be K-edges, so edges in I or J direction may be forbidden in some embodiments. If the subscripts are out of bounds, those terms may be ignored.

$$∀ ( i , j , k ) {NodeY}_{i , j , k} ⇒ {ExistI}_{i - 1 , j , k} ∧ {ExistI}_{i , j , k} ∧ {ExistJ}_{i , j - 1 , k} ∧ {ExistJ}_{i , j , k}$$

Structural internal constraints for degree-1 X-type and Z-type spiders will now be discussed. See diagram 602 of FIG. 6A. Every cube has six possible edges spanning out of it. For every degree-1 cube that is not a Y cube nor a port, it can ‘squeeze in’ to the cube it connects to, like shown on the right. This strictly reduces the spacetime volume of the diagram. Although keeping degree-1 cubes is theoretically valid, it adds complexity when checking other constraints. Therefore, some embodiments forbid degree-1 cubes.

The embodiments achieve so by the constraints discussed below, meaning ‘for each of the two endpoints of an edge, if the cube is not Y or port, then one of the five other adjacent edges must appear.’ P is the set of cubes that are the open end of ports. If the subscripts are out of bounds, the embodiments may ignore that term.

$$∀ {(}_{i , j , k} ) ∉ P [ {NodeY}_{i , j , k} ∧ {ExistI}_{i , j , k} ⇒ [ {ExistI}_{i - 1 , j , k} ∨ {ExistJ}_{i , j , k} ∨ {ExistJ}_{i , j - 1 , k} ∨ {ExistK}_{i , j , k} ∨ {ExistK}_{i , j , k - 1}$$

Structural internal constraints for color match will now be discussed. See diagram 604 of FIG. 6A. For cubes with a degree larger than one, we need to make sure the colors of edges connecting to it match. Otherwise, some error correction property is broken. One non-limiting example of considering cube (i,j,k) is as follows: edge (i−1,j,k)→(i,j,k) and edge (i,j−1,k)→(i,j,k).

There are in total 15 pairs of such edges (6 edges, choose 2). The other 14 constraints are similar to this one. If any of the subscripts are out of bounds, the embodiments may simply ignore this constraint.

$$∀ ( i , j , k ) {ExistI}_{i - 1 , j , k} ∨ {ExistJ}_{i , j - 1 , k} ∨ [ {ColorI}_{i - 1 , j , k} != {ColorJ}_{i , j - 1 , k} ]$$

### Stabilizer Boundary Constraints

The stabilizers are given by n Pauli strings. Suppose stabilizer s is σs, 0 . . . σs, n−1. We give an example if p is I direction (i,j,k,I,*,*). If p is in the J or K direction, the constraint is similar.
If σs, p=I, then no correlation surface is present.

$${CorrIK}_{s , i , j , k} ∧ {CorrIJ}_{s , i , j , k}$$

If σs, p=Z, then the correlation surface touching blue faces is present while the one touching red faces is not.

$$[ {ColorI}_{i , j , k} ∧ {CorrIJ}_{s , i , j , k} ∧ {CorrIK}_{s , i , j , k} ] ∨ [ {ColorI}_{i , j , k} ∧ {CorrIK}_{s , i , j , k} ∧ {CorrIJ}_{s , i , j , k} ]$$

f σs,p=X, then the correlation surface touching red faces is present while the one touching blue faces is not

$$[ {\underline{ColorI}}_{i , j , k} ∧ {\underline{CorrIJ}}_{s , i , j , k} ∧ {CorrIK}_{s , i , j , k} ] ∨ [ {ColorI}_{i , j , k} ∧ {CorrIK}_{s , i , j , k} ∧ {\underline{CorrIJ}}_{s , i , j , k} ]$$

If σ_{s,p}=Y, both correlation surfaces are present.

$${CorrIK}_{s , i , j , k} ∧ {CorrIJ}_{s , i , j , k}$$

### Stabilizer Internal Constraints

FIG. 6B shows various pipe diagrams displaying visual manifestations of various stabilizer boundary constraints, according to various embodiments. For the following discussion, see diagram 606 of FIG. 6B. If the cube is a Y cube, the two correlation surfaces should be both present or both missing. If k−1 is out of bound, the constraint is simply ignored

$$∀ ( i , j , k ) , s {NodeY}_{i , j , k} ∨ [ {CorrKI}_{s , i , j , k - 1} == {CorrKJ}_{s , i , j , k - 1} ]$$

$$∀ ( i , j , k ) , s {NodeY}_{i , j , k} ∨ [ {CorrKI}_{s , i , j , k} == {CorrKJ}_{s , i , j , k} ]$$

If the cube is not a Y cube, then it can only be degree-2, 3, or 4 X- or Z-spider. Degree-1 cubes are forbidden by previous constraints. Degree-5 and 6 nodes (because of the pigeonhole principle) will have edges in all I, J, and K directions. Then, there will be conflicts of color, so degree>4 spiders are ruled out by color matching constraints. Thus, there is a normal direction to the cube and its edges. For example, in FIG. 6B, the normal direction is K since all edges are perpendicular to the K direction. Then, the behavior of correlation surfaces depends on whether they are perpendicular to the normal vector or parallel to the normal vector.

For the following, see diagram 608 of FIG. 6B. If perpendicular, the correlation surfaces should be all present or all missing. An example where the normal vector is K is as follows. For normal vectors I or J, the constraint is similar. The left hand side of constraints means the cube is not Y and indeed K is the normal vector. The right hand side is the OR of two cases: either all or none correlation surfaces in the IJ plane exist in existing edges

$$∀ ( i , j , k ) , s [ {NodeY}_{i , j , k} ∧ {ExistK}_{i , j , k - 1} ∧ {ExistK}_{i , j , k} ] ⇒ ( [ {ExistI}_{i - 1 , j , k} ∨ {CorrIJ}_{s , i - 1 , j , k} ] ∧ [ {ExistI}_{i , j , k} ∨ {CorrIJ}_{s , i , j , k} ] ∧ [ {ExistJ}_{i , j - 1 , k} ∨ CorrJ {I}_{s , i , j - 1 , k} ] ∧ [ Exist {J}_{i , j , k} ∨ CorrJ {I}_{s , i , j , k} ] ) ∨ ( [ Exist {I}_{i - 1 , j , k} ∨ CorrI {J}_{s , i - 1 , j , k} ] ∧ [ {ExistI}_{i , j , k} ∨ {CorrIJ}_{s , i , j , k} ] ∧ [ {ExistJ}_{i , j - 1 , k} ∨ {CorrJI}_{s , i , j - 1 , k} ] ∧ [ {ExistJ}_{i , j , k} ∨ {CorrJI}_{s , i , j , k} ] )$$

For the following, see diagram 610 of FIG. 6B. For correlation surfaces that are parallel to the normal vector, there should be an even number of them. (0, 2, or 4). Below is an example where the normal vector is K. For normal vectors I or J, the constraint is similar.

$$∀ ( i , j , k ) , s [ Node {Y}_{i , j , k} ∧ Exist {K}_{i , j , k - 1} ∧ Exist {K}_{i , j , k} ] ⇒ ( [ Exist {I}_{i - 1 , j , k} ∧ CorrI {K}_{i - 1 , j , k , s} ] ⊕ [ Exist {I}_{i , j , k} ∧ CorrI {K}_{i , j , k , s} ] ⊕ [ Exist {J}_{i , j - 1 , k} ∧ CorrJ {K}_{i , j - 1 , k , s} ] ⊕ [ Exist {J}_{i , j , k} ∧ CorrJ {K}_{i , j , k , s} ] = 0 )$$

### Optimal Lattice Surgery Compiler (OLSCo)

Since the embodiments consider Hadamards on K-edges to be free, one can infer the colors of K-edges from its neighbors and add Hadamards when appropriate. Thus, the embodiments need not have the ColorK* variables in the compiler. Thus, some embodiments need not have color matching constraints for every connectivity that includes K-edges. As a result, some embodiments may add one set of structure internal constraints to forbid ‘3D corners’ by saying there is at least one normal vector for each cube.

$$∀ ( i , j , k ) [ {\underline{ExistI}}_{i - 1 , j , k} ∧ {\underline{ExistI}}_{i , j , k} ] ∨ [ {\underline{ExistJ}}_{i , j - 1 , k} ∧ {\underline{ExistJ}}_{i , j , k} ] ∨ [ {\underline{ExistK}}_{i , j , k - 1} ∧ {\underline{ExistK}}_{i , j , k} ]$$

In post-processing, the ColorK* variables are inferred from the edges that are touching them. There are some degrees of freedom in assigning colors to Z-edges that only touch Z-edge. In post-processing, the embodiments may get rid of the cubes and edges that are not connected to any ports.

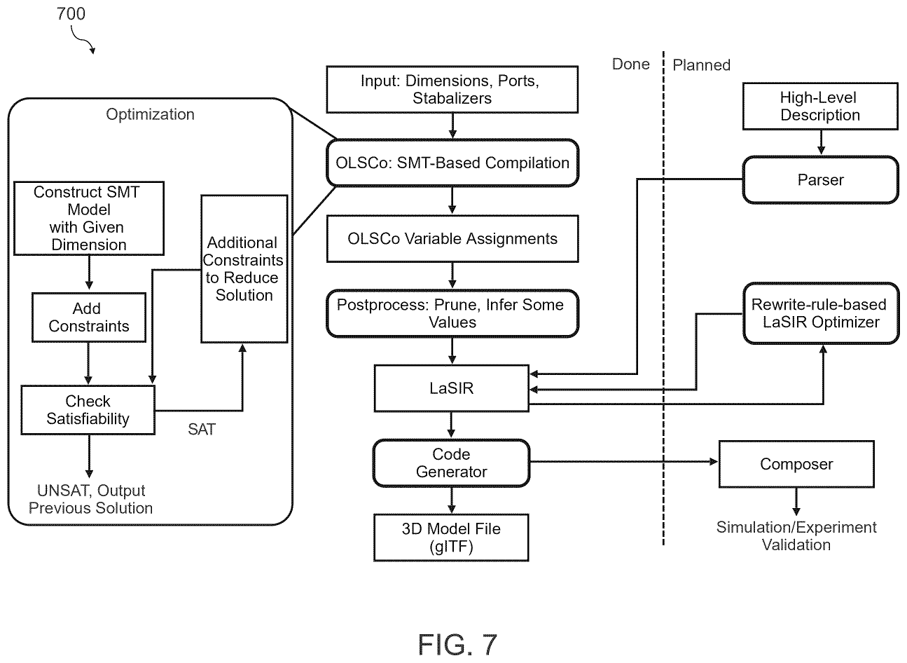

FIG. 7 shows a software structure 700 for a lattice surgery compiler, according to various embodiments. Based on the variables and constraints above, we have developed OLSCo, a Satisfiability Modulo Theories-based compiler for LaSIR, shown in the figure below. The inputs to OLSCo are positive integers nᵢ, nⱼ, nₖ, nₚ=n and nₛ; nₚ ports, each is a 6 number array, the nₛ stabilizers, each is a Pauli string on the np ports.
main.py handles the input, constructs an OLSCo object, and calls the solve method of that object to produce a result *.olsco.
olsco.py declare SMT variables and add all the constraints.
lasir_gen.py post-processes *.olsco to produce a LaSIR instance stored in a file *.lasir.
gltf_gen.py produces a visualization for *.lasir in the format of glTF (GL Transmission Format). This format is royalty-free specification for the efficient transmission and loading of 3D models. Many free tools are available to view such files.

A manually constructed base.gltf containing 3D models of basic components of pipe diagrams is leveraged to construct *.gltf.

The SMT/SAT solver can check whether the model is satisfiable. We can perform optimization with the solver as shown in the figure above. Once we find variable assignments that yield SAT, we can add some constraints to reduce solution space, e.g., Exist* variables in some regions are all 0. Then, we check whether the model is satisfiable again. If so, we have optimized the result; if not, we can conclude that the solution space is reduced too much so that there is no solution.

### Example Methods for Generation and Compilation of Pipe Diagrams

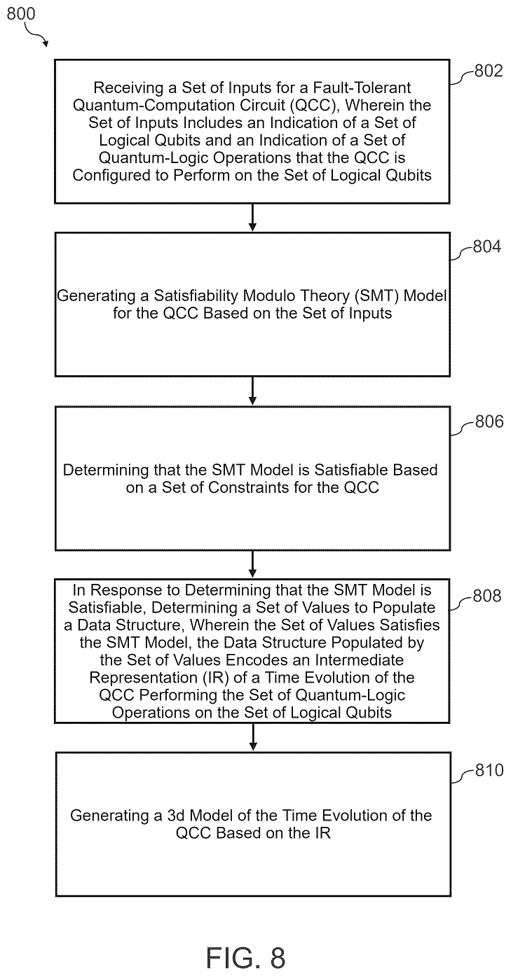

FIG. 8 depicts a flow chart diagram of an example method 800 for implementing fault-tolerant quantum computing, according to various embodiments. Method 800 begins at block 802, a set of inputs for a fault-tolerant quantum-computation circuit (QCC) is received. The set of inputs includes an indication of a set of logical qubits and an indication of a set of quantum-logic stabilizers that the QCC is configured to perform on the set of logical qubits. At block 804, a satisfiability modulo theory (SMT) model for the QCC is generated. Generating the SMT model is based on the set of inputs. The SMT model includes a set of constraints. At block 806, it is determined whether the SMT model is satisfiable based on the set of constraints of the QCC. At block 808, and in response to determining that the SMT model is satisfiable, a set of values to populate a data structure is determined. When the set of values satisfies the SMT model, the data structure populated by the set of values encodes an intermediate representation (IR) of a time evolution of the QCC performing the set of quantum-logic operations on the set of logical qubits. At block 810, a 3D model of the time evolution of the QCC is generated based on the IR.

In some embodiments, method 800 includes that in response to determining that the SMT model is satisfiable, a set of additional constraints for the QCC is received. A reduced search space for the set of values is determined based on the set of additional constraints. It is determined that the SMT model is satisfiable in accordance with the set of additional constraints based on the reduced search space for the set of values. In response to determining that the SMT model is satisfiable in accordance with the set of additional constraint, the set of values to populate the data structure is updated based on the reduced search space. The IR is generated based on the updated set of values to populate the data structure.

An SMT solver may be employed to determine that the SMT model is satisfiable. A visual representation of a pipe diagram may be generated based on the 3D model. The pipe diagram provides a visualization of the time evolution of the QCC. The set of inputs may further include a number of dimensions. The SMT may be based on the number of dimensions. The 3D model may be encoded in a glTF file. Each logical qubit of the set of logical qubits may be encoded in a patch of surface code memory of a quantum computing system (QCS). The IR of the time evolution of the QCC may encode a pipe diagram of the time evolution of the QCC. The set of quantum-logic operations includes lattice surgery operations on the set of logical qubits for the fault-tolerant quantum computing. Each logical qubit of the set of logical qubits may be represented by a cube in the pipe diagram. The pipe diagram includes a set of cubes representing the set of logical qubits and a set of interactions between the logical qubits of the set of qubits.

At least a portion of the cubes in the set of cubes is elongated to generate a tube for the elongated cubes and the pipe diagram includes a set of tubes corresponding to the time evolution of the QCC and the set of interactions between the logical qubits of the set of qubits. A color of each edge of each tube of the set of tubes may indicate a basis for a syndrome measurement corresponding to a boundary of the patch of surface code memory for the corresponding logical qubit. The set of constraints includes a requirement that colors of edges of tubes touching one another must match, indicating that basis for the syndrome measurements of boundaries of patches of the surface code memory being joined must be of a same basis type. The set of inputs may include a set of ports corresponding to the set of logical qubits, a set of structural variables, and a set of correlation surface variables. The set of structural variables specifies a structure of the pipe diagram, and a functionality of the pipe diagram is indicated by a set of stabilizers in the SMT model. Determining that the SMT model is satisfiable includes determining that the SMT model implements the functionality of the pipe diagram via the set of stabilizers. The SMT model may be a Boolean Satisfiability (SAT) model and the data structure includes a set of Boolean variables. Determining the set of values to populate the data structure may include a SMT-based compilation of the QCC.

### ADDITIONAL EMBODIMENTS

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for implementing fault-tolerant quantum computing, the method comprising:
receiving a set of inputs for a fault-tolerant quantum-computation circuit (QCC), wherein the set of inputs includes an indication of a set of logical qubits and an indication of a set of quantum-logic stabilizers that the QCC is configured to perform on the set of logical qubits;
generating a satisfiability modulo theory (SMT) model for the QCC based on the set of inputs, wherein the SMT model includes a set of constraints; and
determining a set of values to populate a data structure, wherein the set of values satisfies the set of constraints of the SMT model, and the data structure populated by the set of values encodes an intermediate representation (IR) of a time evolution of the QCC performing the set of quantum-logic stabilizers on the set of logical qubits.

2. The method of claim 1, further comprising:
in response to determining that the SMT model is satisfiable, receiving a set of additional constraints for the QCC;
determining a reduced search space for the set of values based on the set of additional constraints;
determining that the SMT model is satisfiable in accordance with the set of additional constraints based on the reduced search space for the set of values;
in response to determining that the SMT model is satisfiable in accordance with the set of additional constraint, updating the set of values to populate the data structure based on the reduced search space; and
generating the IR based on the updated set of values to populate the data structure.

3. The method of claim 1, wherein an SMT solver is employed to determine that the SMT model is satisfiable.

4. The method of claim 1, further comprising:
generating a 3D model of time evolution of the QCC based on the IR; and
generating a visual representation of a pipe diagram based on the 3D model, wherein the pipe diagram provides a visualization of the time evolution of the QCC.

5. The method of claim 1, wherein the set of inputs further includes a number of dimensions and the SMT model is based on the number of dimensions.

6. The method of claim 1, further comprising:
generating a 3D model of time evolution of the QCC based on the IR, wherein the 3D model is encoded in a glTF file.

7. The method of claim 1, wherein each logical qubit of the set of logical qubits is encoded in a patch of surface code memory of a quantum computing system (QCS).

8. The method of claim 7, wherein the IR of the time evolution of the QCC encodes a pipe diagram of the time evolution of the QCC and the set of quantum-logic stabilizers includes lattice surgery operations on the set of logical qubits for the fault-tolerant quantum computing.

9. The method of claim 8, wherein each logical qubit of the set of logical qubits is represented by a cube in the pipe diagram and the pipe diagram includes a set of cubes representing the set of logical qubits and a set of interactions between the logical qubits of the set of qubits.

10. The method of claim 9, wherein at least a portion of the cubes in the set of cubes is elongated to generate a tube for the elongated tunes and the pipe diagram includes a set of tubes corresponding to the time evolution of the QCC and the set of interactions between the logical qubits of the set of qubits.

11. The method of claim 10, wherein a color of each edge of each tube of the set of tubes indicates a basis for a syndrome measurement corresponding to a boundary of the patch of surface code memory for the corresponding logical qubit.

12. The method of claim 11, wherein the set of constraints includes a requirement that colors of edges of tubes touching one another must match, indicating that basis for the syndrome measurements of boundaries of patches of the surface code memory being joined must be of a same basis type.

13. The method of claim 12, wherein the set of inputs includes a set of ports corresponding to the set of logical qubits, a set of structural variables, and a set of correlation surface variables.

14. The method of claim 13, wherein the set of structural variables specifies a structure of the pipe diagram, and a functionality of the pipe diagram is indicated by a set of stabilizers in the SMT model.

15. The method of claim 14, wherein determining that the SMT model is satisfiable includes determining that the SMT model implements the functionality of the pipe diagram via the set of stabilizers.

16. The method of claim 1, wherein the SMT model is a Boolean Satisfiability (SAT) model and the data structure includes a set of Boolean variables.

17. The method of claim 1, wherein determining the set of values to populate the data structure includes a SMT-based compilation of the QCC.

18. The method of claim 1, further comprising:
generating a 3D model of the time evolution of the QCC based on the IR; and
performing a simulation of the time evolution of the QCC based on the 3D model.

19. A computing system, comprising:
one or more processor devices;
one or more memory devices, the one or more memory devices storing computer-readable instructions that when executed by the one or more processor devices cause the one or more processor devices to perform operations for implementing fault-tolerant quantum computing, the operations comprising:
receiving a set of inputs for a fault-tolerant quantum-computation circuit (QCC), wherein the set of inputs includes an indication of a set of logical qubits and an indication of a set of quantum-logic stabilizers that the QCC is configured to perform on the set of logical qubits;
generating a satisfiability modulo theory (SMT) model for the QCC based on the set of inputs, wherein the SMT model includes a set of constraints; and
determining a set of values to populate a data structure, wherein the set of values satisfies the set of constraints of the SMT model, and the data structure populated by the set of values encodes an intermediate representation (IR) of a time evolution of the QCC performing the set of quantum-logic stabilizers on the set of logical qubit.

20. The computing system of claim 19, wherein the operations further comprise:
in response to determining that the SMT model is satisfiable, receiving a set of additional constraints for the QCC;
determining a reduced search space for the set of values based on the set of additional constraints;
determining that the SMT model is satisfiable in accordance with the set of additional constraints based on the reduced search space for the set of values;
in response to determining that the SMT model is satisfiable in accordance with the set of additional constraint, updating the set of values to populate the data structure based on the reduced search space; and
generating the IR based on the updated set of values to populate the data structure
